(19) United States
(12) Patent Application Publication
(10) Pub. No.: US 2018/0275941 A1
(43) Pub. Date: Sep. 27, 2018

(54) DISPLAY CONTROL SYSTEM, DISPLAY DATA GENERATION SYSTEM, DISPLAY CONTROL METHOD, AND COMPUTER PROGRAM PRODUCT

(71) Applicant: Kabushiki Kaisha Toshiba, Minato-ku (JP)

(72) Inventors: Dan UMEDA, Nerima (JP); Hidenori MATSUZAKI, Fuchu (JP); Akira KURODA, Yokohama (JP); Xinxiao LI, Yokohama (JP)

(73) Assignee: Kabushiki Kaisha Toshiba, Minato-ku (JP)

(21) Appl. No.: 15/683,924

(22) Filed: Aug. 23, 2017

(30) Foreign Application Priority Data
Mar. 21, 2017 (JP) 2017-054949

(51) Int. Cl. G06F 3/147; G06T 11/20; G06F 17/30

(52) U.S. Cl. CPC G06F 3/147; G06F 17/30994; G06T 11/206

(57) ABSTRACT

According to an embodiment, a display control system includes a memory and one or more hardware processors configured to function as a determining unit, a generating unit, and a display control unit. The determining unit is configured to determine whether to aggregate individual data into aggregated data using a narrowing condition for the individual data. The generating unit is configured to generate the aggregated data from the individual data in a case where the individual data is aggregated into the aggregated data. The display control unit is configured to display the individual data in a case where the individual data is not aggregated into the aggregated data and display the aggregated data in a case where the individual data is aggregated into the aggregated data.

### CROSS-REFERENCE TO RELATED APPLICATIONS

This application is based upon and claims the benefit of priority from Japanese Patent Application No. 2017-054949, filed on Mar. 21, 2017; the entire contents of which are incorporated herein by reference.

### FIELD

Embodiments described herein relate generally to a display control system, a display data generation system, a display control method, and a computer program product.

### BACKGROUND

Technologies for visualizing data are used in various fields such as marketing, technology development, and performance analysis. In recent years, diversification and large scale of data to be visualized are advancing. When data is visualized by display information, problems such as deterioration of visibility and reduction of display speed are likely to occur. In addition, when aggregated data is visualized by display information, display speed can be improved but problems such as a reduction in information amount have been likely to occur.

In the conventional technology, it has been not possible to easily change the information amount of data to be visualized in accordance with the situation.

### BRIEF DESCRIPTION OF THE DRAWINGS

FIG. 1 is a diagram illustrating an example of a functional configuration of a display control system according to a first embodiment;

FIG. 2A is a diagram illustrating an example of individual data according to the first embodiment;

FIG. 2B is a diagram illustrating an example of aggregated data according to the first embodiment;

FIG. 3A is a diagram illustrating a display example 1 of the aggregated data according to the first embodiment;

FIG. 3B is a diagram illustrating a display example 2 of the aggregated data according to the first embodiment;

FIG. 3C is a diagram illustrating a display example 3 of the aggregated data according to the first embodiment;

FIG. 4A is a diagram illustrating a display example of the individual data according to the first embodiment;

FIG. 4B is a diagram illustrating an example of data corresponding to the display example in FIG. 4A;

FIG. 5 is a flowchart illustrating an example of a display control method according to the first embodiment;

FIG. 6 is a diagram illustrating an example of a functional configuration of a display control system according to a second embodiment;

FIG. 7A is a diagram illustrating an example of individual data according to the second embodiment;

FIG. 7B is a diagram illustrating an example of aggregated data according to the second embodiment;

FIG. 8A is a diagram illustrating a display example 1 of the aggregated data according to the second embodiment;

FIG. 8B is a diagram illustrating a display example 2 of the aggregated data according to the second embodiment;

FIG. 8C is a diagram illustrating a display example 3 of the aggregated data according to the second embodiment;

FIG. 9A is a diagram illustrating a display example of the individual data according to the second embodiment;

FIG. 9B is a diagram illustrating an example of data corresponding to the display example in FIG. 9A;

FIG. 10 is a flowchart illustrating an example of a display control method according to the second embodiment;

FIG. 11A is a diagram illustrating an example of individual data according to a third embodiment;

FIG. 11B is a diagram illustrating an example of aggregated data according to the third embodiment;

FIG. 12A is a diagram illustrating a display example 1 of the aggregated data according to the third embodiment;

FIG. 12B is a diagram illustrating a display example 2 of the aggregated data according to the third embodiment;

FIG. 12C is a diagram illustrating a display example 3 of the aggregated data according to the third embodiment;

FIG. 13A is a diagram illustrating a display example of the individual data according to the third embodiment;

FIG. 13B is a diagram illustrating an example of data corresponding to the display example in FIG. 13A;

FIG. 14 is a flowchart illustrating an example of a display control method according to the third embodiment;

FIG. 15 is a diagram illustrating an example of a hardware configuration of the display control systems according to the first to third embodiments;

FIG. 16 is a diagram illustrating an example of a case where the display control system according to each of the first to third embodiments is separated; and

FIG. 17 is a diagram illustrating an example of a hardware configuration in a case where the display control system is separated.

### DETAILED DESCRIPTION

According to an embodiment, a display control system includes a memory and one or more hardware processors configured to function as a determining unit, a generating unit, and a display control unit. The determining unit is configured to determine whether to aggregate individual data into aggregated data using a narrowing condition for the individual data. The generating unit is configured to generate the aggregated data from the individual data in a case where the individual data is aggregated into the aggregated data. The display control unit is configured to display the individual data in a case where the individual data is not aggregated into the aggregated data and display the aggregated data in a case where the individual data is aggregated into the aggregated data.

Embodiments of a display control system, a display data generation system, a display control method, and a computer program product will be described in detail below with reference to the accompanying drawings.

### First Embodiment

First, a first embodiment will be described.

Example of Functional Configuration

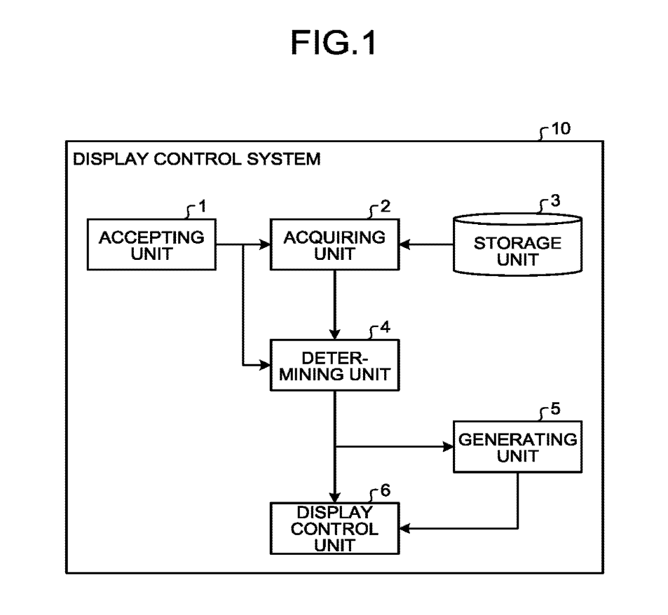

FIG. 1 is a diagram illustrating an example of a functional configuration of a display control system 10 according to the first embodiment. The display control system 10 according to the first embodiment includes an accepting unit 1, an acquiring unit 2, a storage unit 3, a determining unit 4, a generating unit 5, and a display control unit 6.

The accepting unit 1 accepts a narrowing condition for individual data. The narrowing condition for the individual data can be arbitrary. For example, the narrowing condition is a range of the date and time when the individual data was acquired. Alternatively, for example, the narrowing condition is a numerical value range when the individual data includes numerical values. The accepting unit 1 inputs the accepted narrowing condition to the acquiring unit 2 and the determining unit 4.

Upon accepting the narrowing condition from the accepting unit 1, the acquiring unit 2 acquires the individual data stored in the storage unit 3 corresponding to this narrowing condition. The individual data stored in the storage unit 3 can be arbitrary. The acquiring unit 2 inputs the acquired individual data to the determining unit 4.

The determining unit 4 accepts the narrowing condition from the accepting unit 1 and accepts the individual data from the acquiring unit 2. Using the narrowing condition, the determining unit 4 determines whether to aggregate the individual data.

For example, in a case where the narrowing condition is a range of the date and time when the individual data was acquired, the determining unit 4 determines to aggregate the individual data as long as the narrowing condition is expressed in monthly, weekly, or daily units. Specifically, when the range of the date and time indicated by the narrowing condition is three months (90 days), for example, the determining unit 4 determines to aggregate the individual data. Meanwhile, when the narrowing condition is in hourly units, the determining unit 4 determines not to aggregate the individual data.

Alternatively, for example, the determining unit 4 determines whether to aggregate the individual data on the basis of whether the amount of this individual data narrowed down by the narrowing condition is equal to or larger than a threshold value.

In the case of aggregating the individual data, the determining unit 4 inputs the individual data to the generating unit 5 and, in the case of not aggregating the individual data, inputs the individual data to the display control unit 6.

Upon accepting the individual data from the determining unit 4, the generating unit 5 aggregates this individual data to generate aggregated data. Note that the method of aggregating the individual data can be arbitrary.

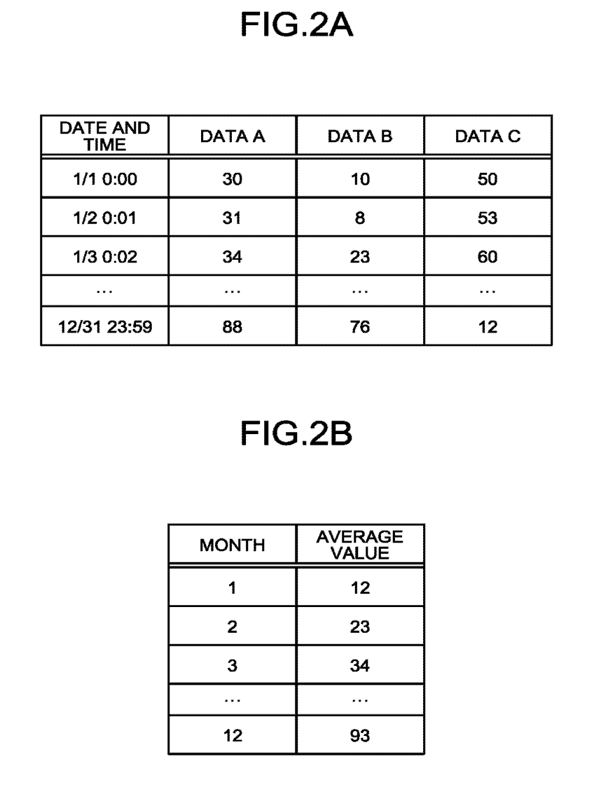

FIG. 2A is a diagram illustrating an example of the individual data according to the first embodiment. The individual data of the first embodiment includes date and time, data A, data B, and data C. The date and time indicates the date and time when the data A, the data B, and the data C were observed. The data A, the data B, and the data C are numerical values.

FIG. 2B is a diagram illustrating an example of the aggregated data according to the first embodiment. The aggregated data of the first embodiment includes the month and an average value. That is, the example in FIG. 2B illustrates a case where the individual data in FIG. 2A is aggregated into aggregated data indicating average values in monthly units. For example, the average value of the data A, the data B and the data C in January is 12.

Note that the aggregated data is not limited to the average value and can be arbitrary. The aggregated data is a value obtained by, for example, computing individual data statistically. The value obtained by the statistical computation is, for example, a statistical value such as a representative value. The representative value is, for example, an aforementioned average value, a median value, and a mode value.

Furthermore, an aggregation unit of the aggregated data is not limited to a monthly unit and can be arbitrary. In addition, the statistical value used for the aggregated data is not limited to one and may be plural. For example, the generating unit 5 may generate the aggregated data by calculating at least one of the average value, the median value, and the mode value for each predetermined aggregation unit from the individual data.

Returning to FIG. 1, the generating unit 5 inputs the aggregated data to the display control unit 6.

Upon accepting the individual data from the determining unit 4, the display control unit 6 displays this individual data. Furthermore, upon accepting the aggregated data from the generating unit 5, the display control unit 6 displays this aggregated data.

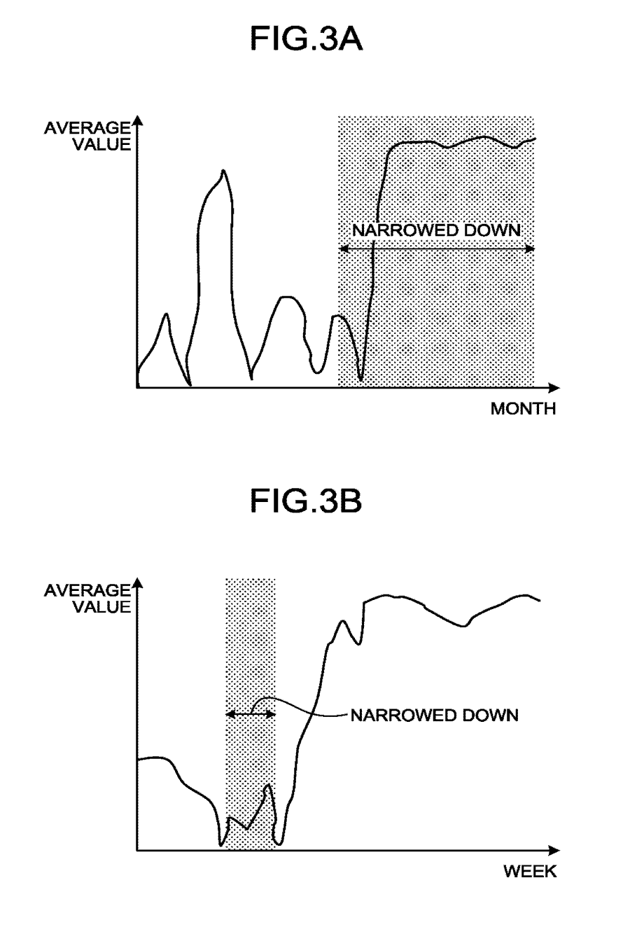

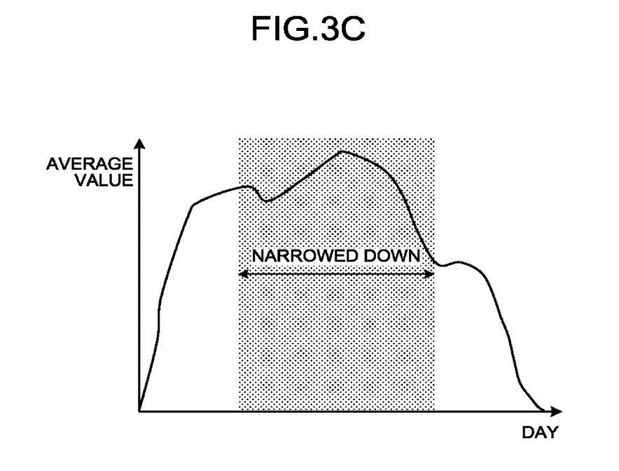

FIG. 3A is a diagram illustrating a display example 1 of the aggregated data according to the first embodiment. The display example 1 in FIG. 3A is a graph where a horizontal axis corresponds to the month and a vertical axis corresponds to the average value. That is, in the example in FIG. 3A, each individual data is not displayed but the average value of this individual data is displayed as the aggregated data. The display control unit 6 updates the graph to be displayed when a narrowing condition is expressed in a week unit which is smaller than current narrowing condition is accepted by the accepting unit 1 (refer to FIG. 3B).

FIG. 3B is a diagram illustrating a display example 2 of the aggregated data according to the first embodiment. The display example 2 in FIG. 3B is a graph where a horizontal axis corresponds to the week and a vertical axis corresponds to the average value. That is, in the example in FIG. 3B, each individual data is not displayed but the average value of this individual data is displayed as the aggregated data. The display control unit 6 updates the graph to be displayed when a narrowing condition expressed in a day unit which is smaller than current narrowing condition is accepted by the accepting unit 1 (refer to FIG. 3C).

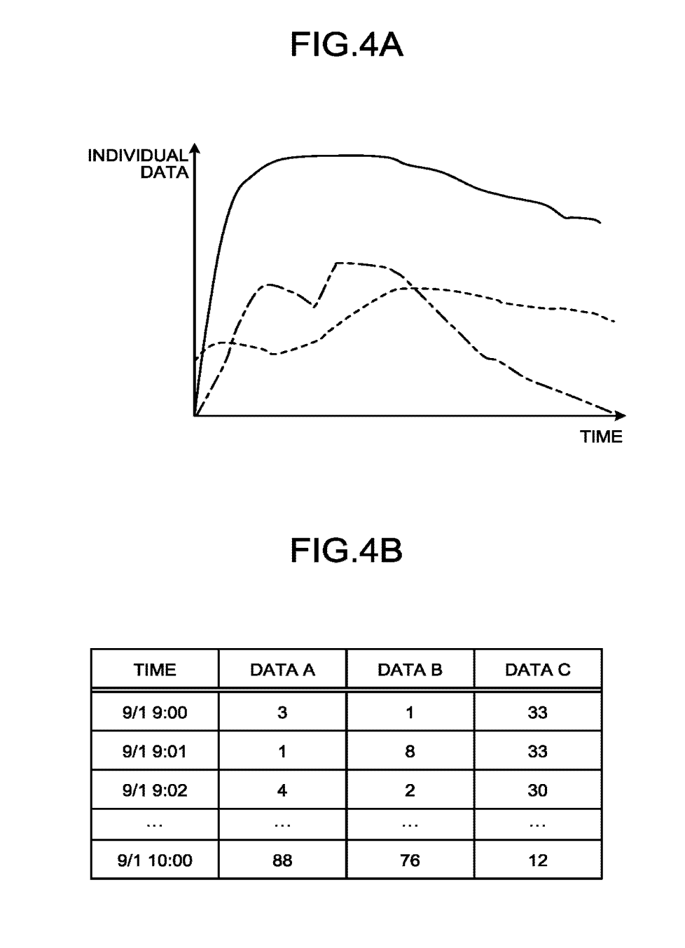

FIG. 3C is a diagram illustrating a display example 3 of the aggregated data according to the first embodiment. The display example 3 in FIG. 3C is a graph where a horizontal axis corresponds to the day and a vertical axis corresponds to the average value. That is, in the example in FIG. 3C, each individual data is not displayed but the average value of this individual data is displayed as the aggregated data. The display control unit 6 updates the graph to be displayed when a narrowing condition expressed in a time unit which is smaller than current narrowing condition is accepted by the accepting unit 1 (refer to FIG. 4A).

FIG. 4A is a diagram illustrating a display example of the individual data according to the first embodiment. FIG. 4B is a diagram illustrating an example of the individual data corresponding to the display example in FIG. 4A. The display example in FIG. 4A is a graph where a horizontal axis corresponds to the time and a vertical axis corresponds to the value of each individual data. That is, in the display example in FIG. 4A, each individual data in FIG. 4B is displayed.

In a case where the amount of individual data to be displayed is large (in a case where the amount of individual data is equal to or larger than the threshold value), the display control unit 6 performs display control as illustrated in FIGS. 3A to 3C and FIG. 4A described above, whereby the information is displayed in a bird's-eye view manner by the aggregated data. As a result, the display information is drawn at a higher speed and thus, a user can refer to the display information without stress. Meanwhile, when the amount of individual data to be displayed is small (in a case where the amount of individual data is less than the threshold value), the information is displayed in a detail view by the individual data. Therefore, the user can switch between the bird's-eye view display and the detailed view display more easily to browse by simply changing the narrowing condition.

Next, a display control method according to the first embodiment will be described.

Example of Display Control Method

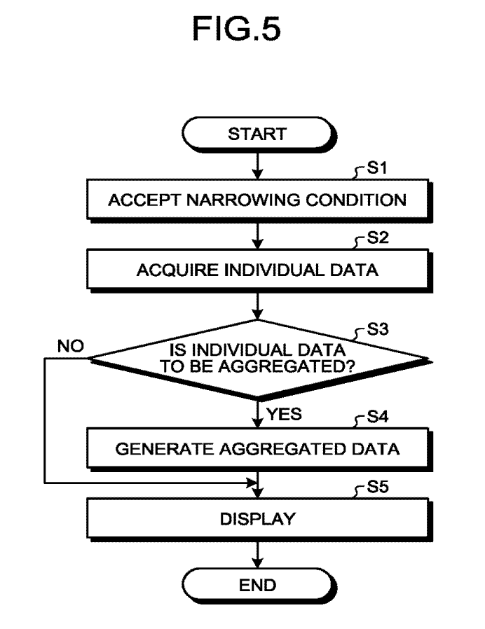

FIG. 5 is a flowchart illustrating an example of the display control method according to the first embodiment. First, the accepting unit 1 accepts a narrowing condition for the individual data (step S1). Next, the acquiring unit 2 acquires the individual data stored in the storage unit 3 using the narrowing condition accepted through the processing in step S1 (step S2).

Next, the determining unit 4 determines whether to aggregate the individual data acquired in the processing in step S2 using the narrowing condition accepted in the processing in step S1 (step S3).

In the case of aggregating the individual data (step S3, Yes), the generating unit 5 generates aggregated data by aggregating the individual data (step S4). In the case of not aggregating the individual data (step S3, No), the processing proceeds to step S5.

Next, the display control unit 6 displays the individual data acquired through the processing in step S2 or the aggregated data generated through the processing in step S4 (step S5).

As described thus far, in the display control system 10 according to the first embodiment, the determining unit 4 determines whether to aggregate the individual data into the aggregated data using the narrowing condition for the individual data. When determining unit 4 determines to aggregate the individual data, the generating unit 5 generates the aggregated data from the individual data. Then, in a case where the individual data is not aggregated into the aggregated data, the display control unit 6 displays the individual data and, in a case where the individual data is aggregated into the aggregated data, displays the aggregated data.

Thus, according to the display control system 10 of the first embodiment, it is possible to more easily change the information amount of data to be visualized in accordance with the situation.

### Second Embodiment

Next, a second embodiment will be described. In the description of the second embodiment, the same explanation as in the first embodiment will be omitted and points different from the first embodiment will be described.

Example of Functional Configuration

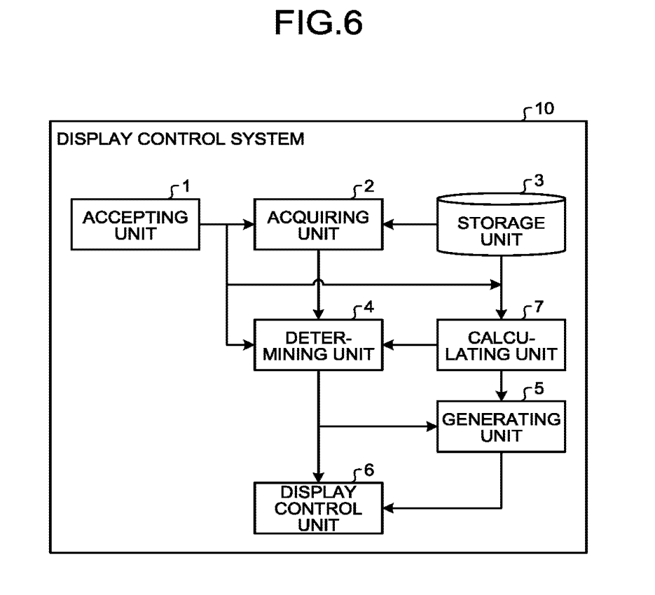

FIG. 6 is a diagram illustrating an example of a functional configuration of a display control system 10 according to the second embodiment. The display control system 10 according to the second embodiment includes the accepting unit 1, the acquiring unit 2, the storage unit 3, the determining unit 4, the generating unit 5, the display control unit 6, and a calculating unit 7. That is, the display control system 10 of the second embodiment is different from the display control system 10 of the first embodiment in that it further includes the calculating unit 7.

The calculating unit 7 calculates display density from the above-described narrowing condition and display area information. The display area information is information indicating the size of a display area. The display density indicates the density when the individual data narrowed down by the narrowing condition is displayed in the display area. The display density is calculated, for example, by (the number of individual data items narrowed down by the narrowing condition)/(the number of individual data items displayable in the display area).

The determining unit 4 determines whether to aggregate the individual data into the above-described aggregated data using the display density. Specifically, for example, when the display density is larger than a threshold value, the determining unit 4 determines to aggregate the individual data into the aggregated data. The threshold value can be arbitrary. The threshold value is, for example, 1.

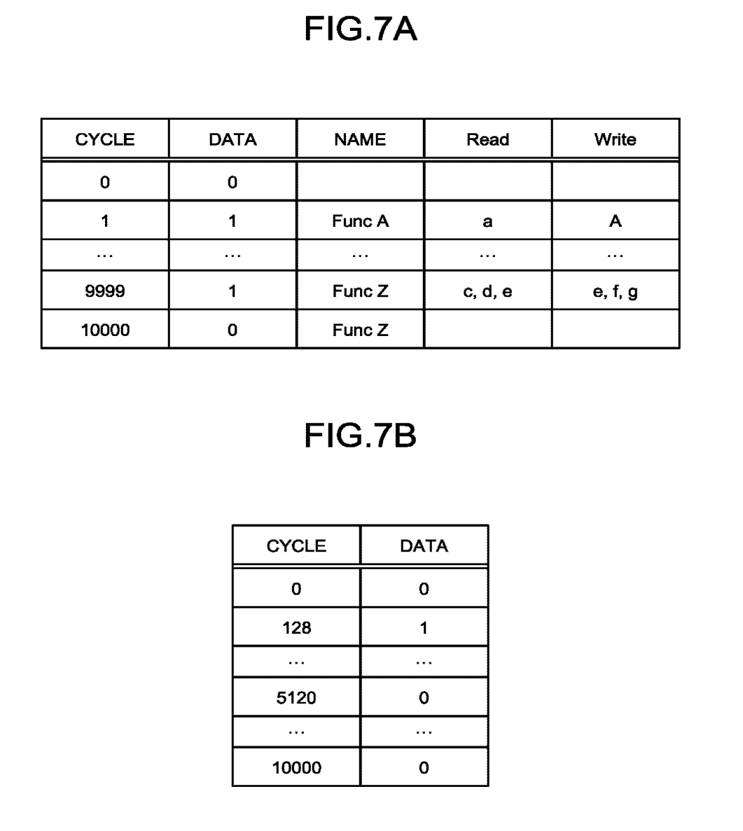

FIG. 7A is a diagram illustrating an example of the individual data according to the second embodiment. The individual data of the second embodiment includes basic information and additional information. The basic information includes a CYCLE and DATA. The additional information includes a NAME, Read, and Write. The CYCLE is a period in which an instruction is executed. The DATA indicates 0 or 1. For example, 0 indicates a state in which a processor is not in use, whereas 1 indicates a state in which the processor is in use. The NAME indicates the name of the instruction. The Read indicates a variable read by the instruction. The Write indicates a variable to be written by the instruction.

FIG. 7B is a diagram illustrating an example of the aggregated data according to the second embodiment. The aggregated data of the second embodiment includes the CYCLE and the DATA. That is, the example in FIG. 7B illustrates a case where the individual data in FIG. 7A is aggregated into the basic information for every 128 cycles. The example in FIG. 7B illustrates the aggregated data which includes the basic information but does not include the additional information.

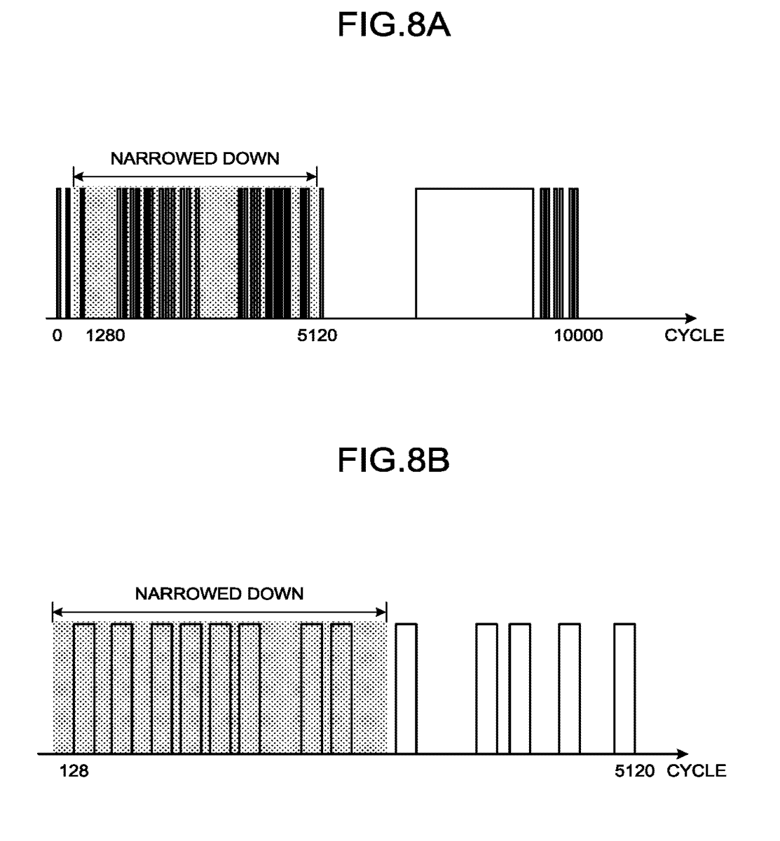

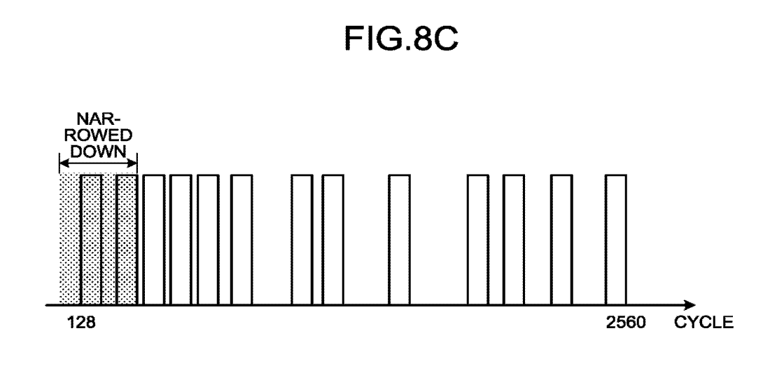

FIG. 8A is a diagram illustrating a display example 1 of the aggregated data according to the second embodiment. The display example 1 in FIG. 8A is a diagram where a horizontal axis represents the CYCLE and a vertical axis represents DATA of 0 or 1. FIG. 8A illustrates a case where the above-described display density is 128. That is, in the example in FIG. 8A, the additional information included in the individual data is not displayed but the basic information included in the individual data is displayed as the aggregated data. The display control unit 6 updates the diagram to be displayed when a narrowing condition having a smaller range is accepted by the accepting unit 1 (refer to FIG. 8B).

FIG. 8B is a diagram illustrating a display example 2 of the aggregated data according to the second embodiment. The display example 2 in FIG. 8B is a diagram where a horizontal axis represents the CYCLE and a vertical axis represents DATA of 0 or 1. FIG. 8B illustrates a case where the above-described display density is 64. That is, in the example in FIG. 8B, the additional information included in the individual data is not displayed but the basic information included in the individual data is displayed as the aggregated data. The display control unit 6 updates the diagram to be displayed when a narrowing condition having a smaller range is accepted by the accepting unit 1 (refer to FIG. 8C).

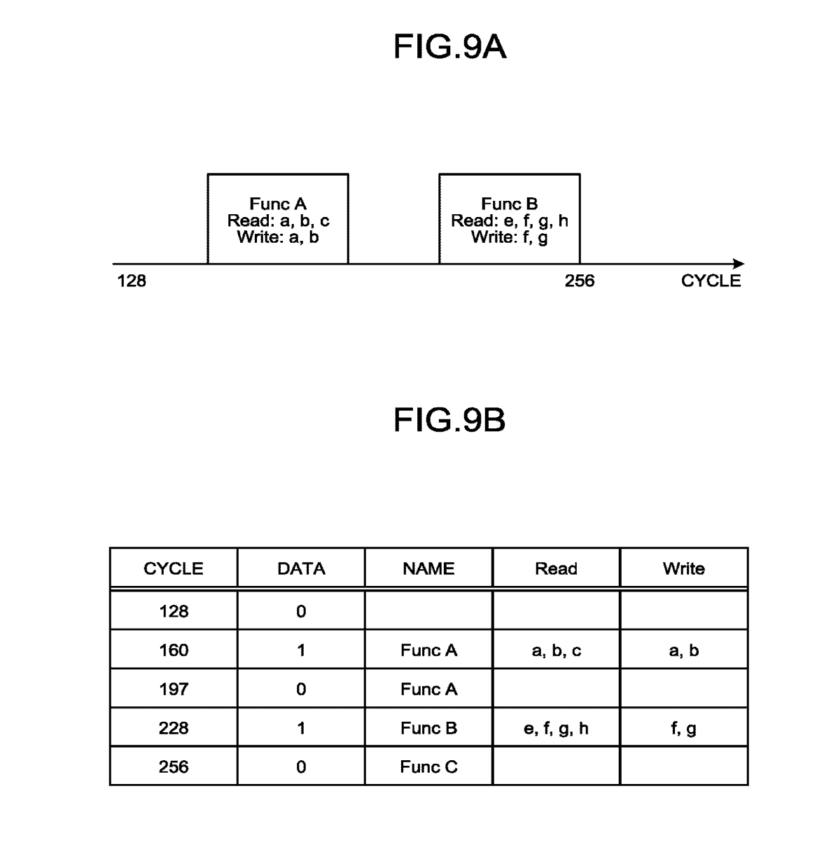

FIG. 8C is a diagram illustrating a display example 3 of the aggregated data according to the second embodiment. The display example 3 in FIG. 8C is a diagram where a horizontal axis represents the CYCLE and a vertical axis represents DATA of 0 or 1. FIG. 8C illustrates a case where the above-described display density is 32. That is, in the example in FIG. 8C, the additional information included in the individual data is not displayed but the basic information included in the individual data is displayed as the aggregated data. The display control unit 6 updates the diagram to be displayed when a narrowing condition having a smaller range is accepted by the accepting unit 1 (refer to FIG. 9A).

FIG. 9A is a diagram illustrating a display example of the individual data according to the second embodiment. FIG. 9B is a diagram illustrating an example of the individual data corresponding to the display example in FIG. 9A. FIG. 9A illustrates a case where the above-described display density is 1. The display example in FIG. 9A is a diagram where a horizontal axis represents the CYCLE and a vertical axis represents DATA of 0 or 1. In the display example in FIG. 9A, the additional information included in the individual data in FIG. 9B (NAME, Read, and Write) is further displayed.

Next, a display control method according to the second embodiment will be described.

Example of Display Control Method

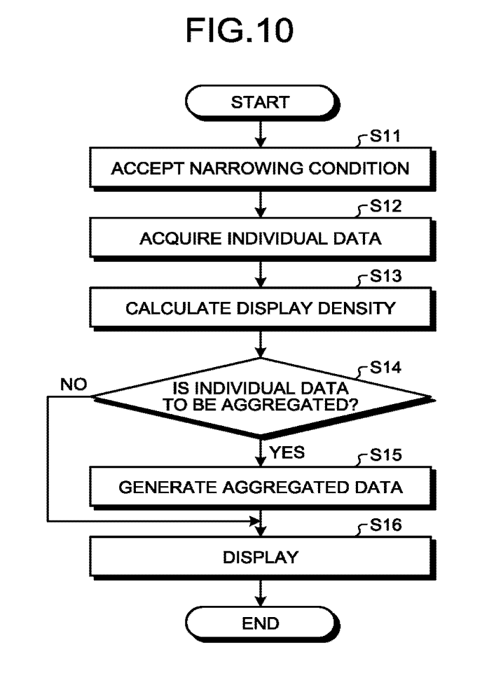

FIG. 10 is a flowchart illustrating an example of the display control method according to the second embodiment. First, the accepting unit 1 accepts a narrowing condition for the individual data (step S11). Next, the acquiring unit 2 acquires the individual data stored in the storage unit 3 using the narrowing condition accepted through the processing in step S11 (step S12).

Next, the calculating unit 7 calculates the display density from the narrowing condition accepted through the processing in step S11 and the display area information (step S13).

Next, the determining unit 4 determines whether to aggregate the individual data acquired through the processing in step S12 using the display density calculated through the processing in step S13 (step S14).

In the case of aggregating the individual data (step S14, Yes), the generating unit 5 generates aggregated data by aggregating the individual data (step S15). In the case of not aggregating the individual data (step S14, No), the processing proceeds to step S16.

Next, the display control unit 6 displays the individual data acquired through the processing in step S12 or the aggregated data generated through the processing in step S15 (step S16).

As described thus far, in the display control system 10 according to the second embodiment, the determining unit 4 determines whether to aggregate the individual data into the aggregated data using the display density. Then, in a case where the individual data is not aggregated into the aggregated data, the display control unit 6 displays the individual data and, in a case where the individual data is aggregated into the aggregated data, displays the aggregated data.

Thus, according to the display control system 10 of the second embodiment, it is possible to more easily change the information amount of data to be visualized in accordance with the situation.

### Third Embodiment

Next, a third embodiment will be described. In the description of the third embodiment, the same explanation as in the first embodiment will be omitted and points different from the first embodiment will be described. The explanation of the functional configuration of a display control system 10 according to the third embodiment is the same as that of the first embodiment and therefore will be omitted.

A determining unit 4 determines whether to aggregate the individual data into the aggregated data on the basis of the number of display objects drawn on the basis of the individual data narrowed down by the narrowing condition. Specifically, for example, when the number of display objects is equal to or larger than a threshold value, the determining unit 4 determines to aggregate the individual data into the aggregated data. Note that the display object can be arbitrary. The display object is, for example, a bar of a bar graph.

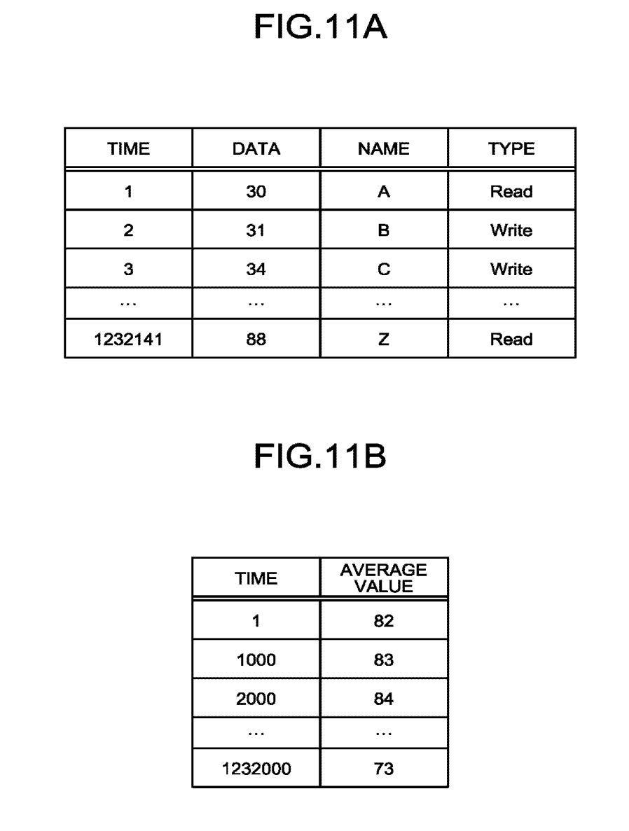

FIG. 11A is a diagram illustrating an example of the individual data according to the third embodiment. The individual data of the third embodiment includes basic information and additional information. The basic information includes TIME and DATA. The additional information includes NAME and TYPE. The TIME indicates the time when the DATA was observed. A manner of time representation can be arbitrary. In the example in FIG. 11A, the TIME is represented by a count value. The DATA indicates a numerical value. The NAME indicates the name of the DATA. The TYPE indicates Read or Write. The Read indicates that the DATA has been read. The Write indicates that the DATA has been written.

FIG. 11B is a diagram illustrating an example of the aggregated data according to the third embodiment. The aggregated data of the third embodiment includes the TIME and an average value. That is, the example in FIG. 11B illustrates a case where the individual data in FIG. 11A is aggregated into an average value in 1000-count units and the additional information is omitted.

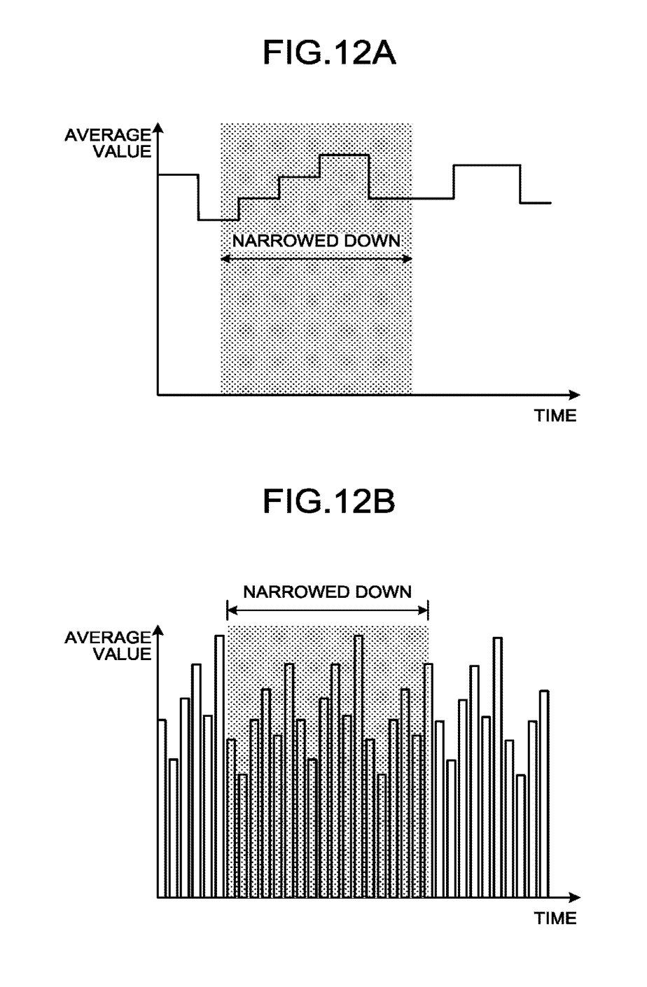

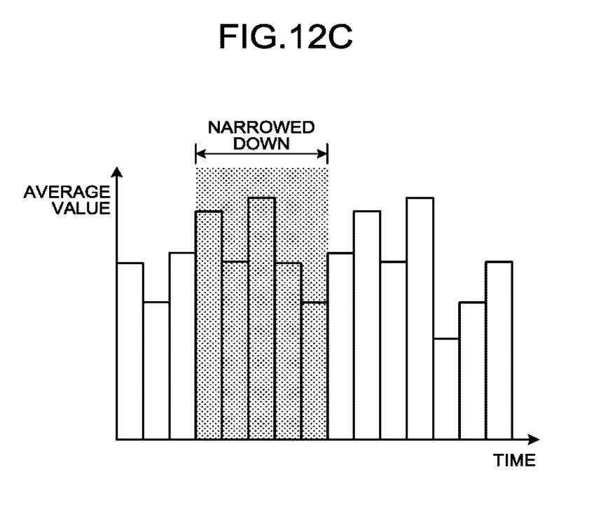

FIG. 12A is a diagram illustrating a display example 1 of the aggregated data according to the third embodiment. The display example 1 in FIG. 12A is a bar graph where a horizontal axis represents the TIME and a vertical axis represents the average value. Note that, in the example in FIG. 12A, since the number of display object which is the number of bars of the bar graph is a lot, the notation thereof is omitted. The additional information included in the individual data is not displayed in the example in FIG. 12A. In addition, data included in the basic information of the individual data is displayed by the average value in the example in FIG. 12A. The display control unit 6 updates the bar graph to be displayed when a narrowing condition having a more smaller time range is accepted by the accepting unit 1 (refer to FIG. 12B).

FIG. 12B is a diagram illustrating a display example 2 of the aggregated data according to the third embodiment. The display example 2 in FIG. 12B is a bar graph where a horizontal axis represents the TIME and a vertical axis represents the average value. The additional information included in the individual data is not displayed in the example in FIG. 12B. In addition, data included in the basic information of the individual data is displayed by the average value in the example in FIG. 12B. The display control unit 6 updates the bar graph to be displayed when a narrowing condition having a more smaller time range is accepted by the accepting unit 1 (refer to FIG. 12C).

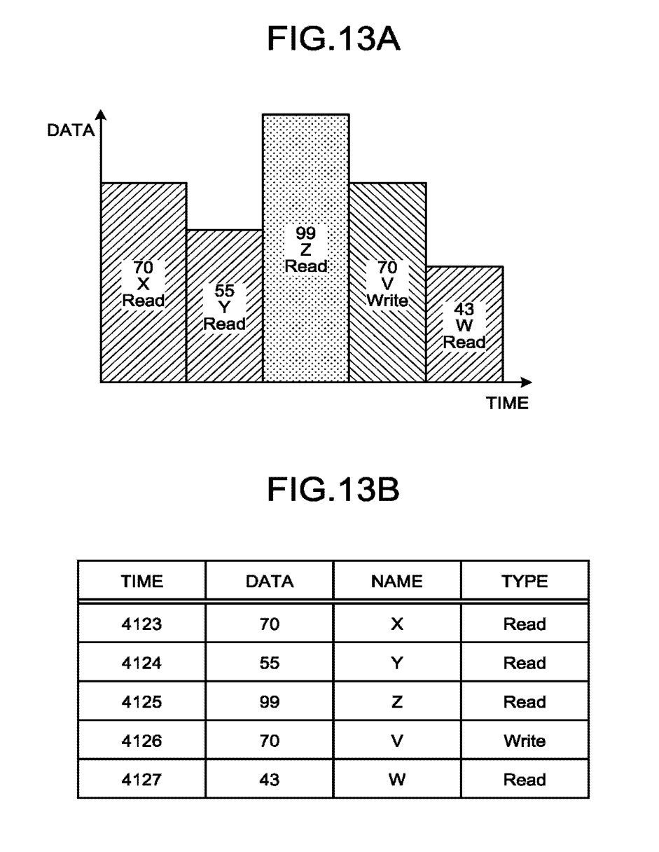

FIG. 12C is a diagram illustrating a display example 3 of the aggregated data according to the third embodiment. The display example 3 in FIG. 12C is a bar graph where a horizontal axis represents the TIME and a vertical axis represents the average value. The additional information included in the individual data is not displayed in the example in FIG. 12C. In addition, data included in the basic information of the individual data is displayed by the average value in the example in FIG. 12C. The display control unit 6 updates the bar graph to be displayed when a narrowing condition having a more smaller time range is accepted by the accepting unit 1 (refer to FIG. 13A).

FIG. 13A is a diagram illustrating a display example of the individual data according to the third embodiment. FIG. 13B is a diagram illustrating an example of the individual data corresponding to the display example in FIG. 13A. The display example in FIG. 13A is a diagram where a horizontal axis represents the TIME and a vertical axis represents data. In the display example in FIG. 13A, the additional information included in the individual data in FIG. 13B (NAME and TYPE) is further displayed.

Next, a display control method according to the third embodiment will be described.

Example of Display Control Method

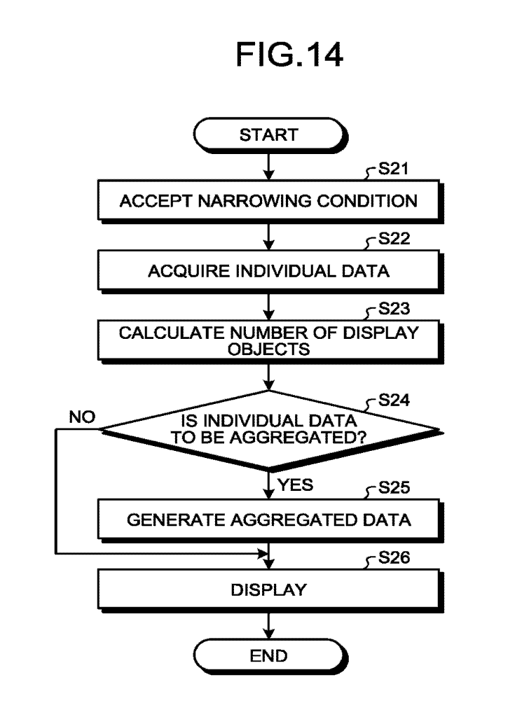

FIG. 14 is a flowchart illustrating an example of a display control method according to the third embodiment. First, the accepting unit 1 accepts a narrowing condition for the individual data (step S21). Next, the acquiring unit 2 acquires the individual data stored in the storage unit 3 using the narrowing condition accepted through the processing in step S21 (step S22).

Next, the determining unit 4 calculates the number of display objects to be drawn on the basis of the individual data narrowed down by the narrowing condition accepted through the processing in step S22 (step S23).

Next, the determining unit 4 determines whether to aggregate the individual data acquired through the processing in step S22 using the number of display objects calculated through the processing in step S23 (step S24). Note that the data which is used for the determining is not limited to the number of display objects. The determining unit 4 may use the number of individual data instead of the number of display objects.

In the case of aggregating the individual data (step 324, Yes), the generating unit 5 generates aggregated data by aggregating the individual data (step S25). In the case of not aggregating the individual data (step S24, No), the processing proceeds to step S26.

Next, the display control unit 6 displays the individual data acquired through the processing in step S22 or the aggregated data generated through the processing in step S25 (step S26).

As described thus far, in the display control system 10 according to the third embodiment, the determining unit 4 determines whether to aggregate the individual data into the aggregated data using the number of display objects. Then, in a case where the individual data is not aggregated into the aggregated data, the display control unit 6 displays the individual data and, in a case where the individual data is aggregated into the aggregated data, displays the aggregated data.

Thus, according to the display control system 10 of the third embodiment, it is possible to more easily change the information amount of data to be visualized in accordance with the situation.

Finally, an example of a hardware configuration of the display control systems 10 according to the first to third embodiments will be described.

Example of Hardware Configuration

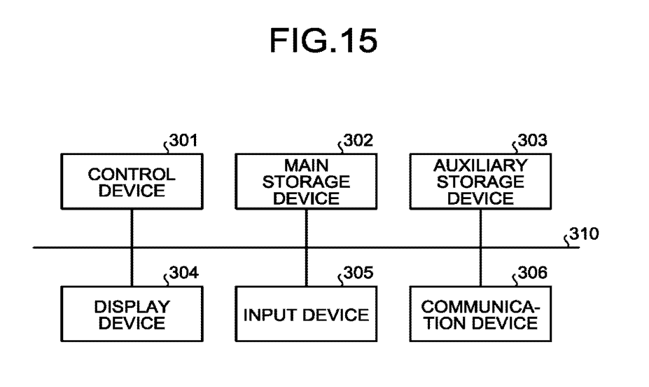

FIG. 15 is a diagram illustrating an example of the hardware configuration of the display control systems 10 according to the first to third embodiments. The display control system 10 of each of the first to third embodiments includes a control device 301, a main storage device 302, an auxiliary storage device 303, a display device 304, an input device 305, and a communication device 306. The control device 301, the main storage device 302, the auxiliary storage device 303, the display device 304, the input device 305, and the communication device 306 are connected via a bus 310.

The control device 301 executes a program read from the auxiliary storage device 303 to the main storage device 302. The control device 301 is, for example, one or more processors such as CPUs. The main storage device 302 is a memory such as a read only memory (ROM) and a random access memory (RAM). The auxiliary storage device 303 is a memory card, a hard disk drive (HDD), or the like.

The display device 304 displays information. The display device 304 is, for example, a liquid crystal display. The input device 305 accepts input of information. The input device 305 is, for example, a keyboard and a mouse. Note that the display device 304 and the input device 305 may be a liquid crystal touch panel or the like that serves as both of a display function and an input function. The communication device 306 communicates with other devices.

A program executed by the display control system 10 according to each of the first to third embodiments is provided as a computer program product by being stored in a computer readable storage medium such as a CD-ROM, a memory card, a CD-R, and a digital versatile disc (DVD) as a file in an installable format or executable format.

Alternatively, the program executed by the display control system 10 according to each of the first to third embodiments may be configured so as to be saved and kept in a computer connected to a network such as the Internet and provided by being downloaded by way of the network. Alternatively, the program executed by the display control system 10 according to each of the first to third embodiments may be configured so as to be provided by way of a network such as the Internet without being downloaded.

Alternatively, the program executed by the display control system 10 according to each of the first to third embodiments may be configured so as to be provided by being incorporated in a ROM or the like in advance.

The program executed by the display control system 10 according to each of the first to third embodiments has a module configuration including functions realizable by a program among the functional configuration of the display control system 10 according to each of the first to third embodiments.

A function realized by the program is loaded into the main storage device 302 by the control device 301 reading the program from a storage medium such as the auxiliary storage device 303 to execute. That is, the function realized by the program is generated on the main storage device 302.

Part of the functions of the display control system 10 according to each of the first to third embodiments may be realized by hardware such as an integrated circuit (IC). The IC is, for example, a processor that executes dedicated processing.

In a case where respective functions are realized using a plurality of processors, each processor may realize one of these functions or may realize two or more of these functions.

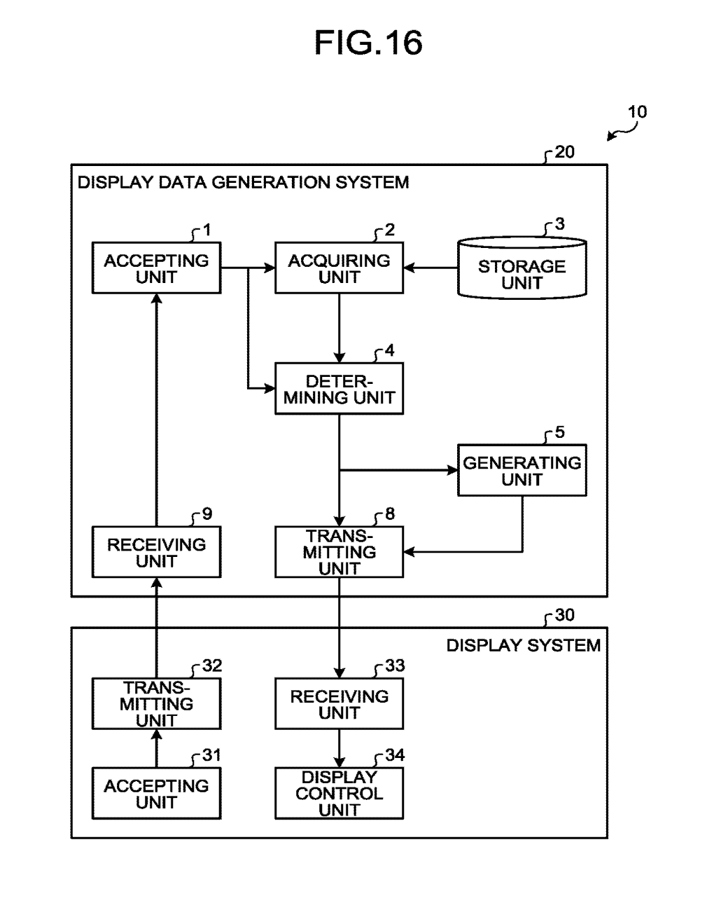

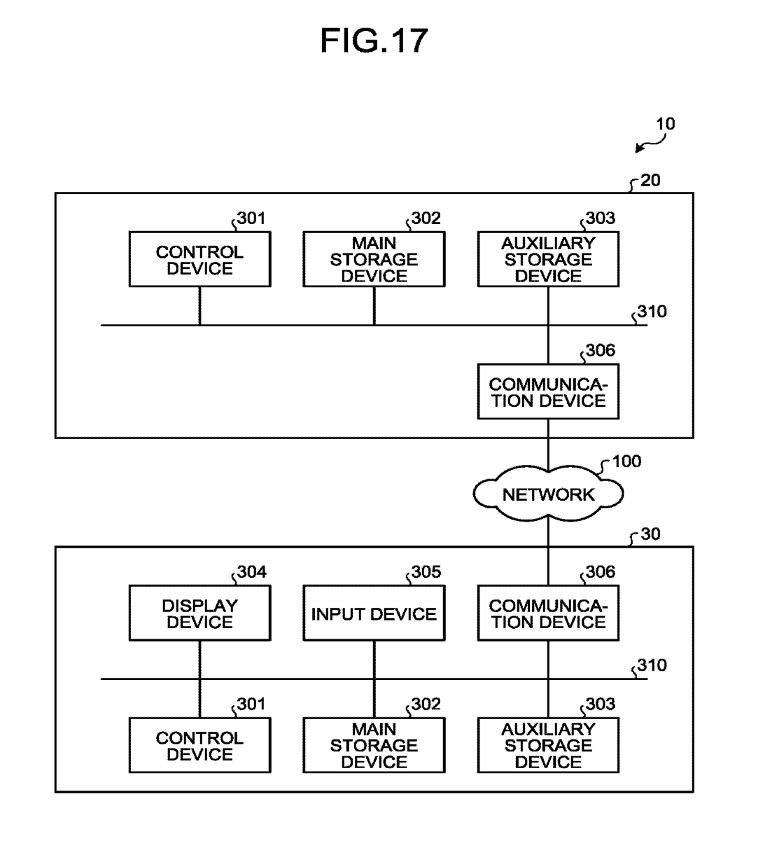

Furthermore, the operation mode of the display control system 10 according to each of the first to third embodiments can be arbitrary. The display control system 10 according to each of the first to third embodiments may be operated as, for example, a cloud system on a network. For example, as illustrated in FIG. 16, the display control system 10 may be separated into a display data generation system 20 and a display system 30 such that the display system 30 (client) and the display data generation system 20 (server) are separated with a network 100 interposed therebetween. The separated display data generation system 20 includes, for example, the accepting unit 1, the acquiring unit 2, the storage unit 3, the determining unit 4, and generating unit 5 that are illustrated in FIG. 1, and additionally includes a transmitting unit 8 and a receiving unit 9 for communicating with the display system 30. And, the separated display system 30 includes, for example, an accepting unit 31 that accepts information from outside, a transmitting unit 32 that transmits the information accepted by the accepting unit 31 to the display data generation system 20, a receiving unit 33 that receives data from the display data generation system 20, and a display control unit 34 that displays the data received by the receiving unit 33. In this case, the hardware configuration is represented as illustrated in FIG. 17.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display control system comprising:
a memory; and
one or more hardware processors configured to function as a determining unit, a generating unit, and a display control unit, wherein
the determining unit configured to determine whether to aggregate individual data into aggregated data using a narrowing condition for the individual data;
the generating unit configured to generate the aggregated data from the individual data in a case where the individual data is aggregated into the aggregated data; and
the display control unit configured to display the individual data in a case where the individual data is not aggregated into the aggregated data and display the aggregated data in a case where the individual data is aggregated into the aggregated data.

2. The display control system according to claim 1, wherein
the generating unit is configured to generate the aggregated data from the individual data by statistically computing the individual data.

3. The display control system according to claim 2, wherein
the generating unit is configured to generate the aggregated data by calculating at least one of an average value, a median value, and a mode value for each predetermined aggregation unit from the individual data.

4. The display control system according to claim 1, wherein
in a case where the amount of the individual data narrowed down by the narrowing condition is equal to or larger than a threshold value, the determining unit is configured to determine to aggregate the individual data into the aggregated data.

5. The display control system according to claim 1, wherein the one or more processors are further configured to function as a calculating unit configured to calculate display density from the narrowing condition and display area information, wherein
the determining unit is configured to determine whether to aggregate the individual data into the aggregated data using the display density.

6. The display control system according to claim 5, wherein
the individual data includes basic data and additional data,
in a case where the display density is larger than a threshold value, the determining unit determines to aggregate the individual data into the aggregated data, and
in a case where the individual data is aggregated into the aggregated data, the generating unit aggregates the individual data into the aggregated data by deleting the additional data from the individual data.

7. The display control system according to claim 1, wherein
the determining unit is configured to determine whether to aggregate the individual data into the aggregated data based on the number of display objects that is drawn based on the individual data narrowed down by the narrowing condition.

8. A display data generation system comprising:
a memory; and
one or more hardware processors configured to function as a determining unit, a generating unit, and a transmitting unit, wherein
the determining unit configured to determine whether to aggregate individual data into aggregated data using a narrowing condition for the individual data;
the generating unit configured to generate the aggregated data from the individual data in a case where the individual data is aggregated into the aggregated data; and
the transmitting unit configured to transmit the individual data in a case where the individual data is not aggregated into the aggregated data and transmit the aggregated data in a case where the individual data is aggregated into the aggregated data.

9. A display control method comprising:
determining whether to aggregate individual data into aggregated data using a narrowing condition for the individual data;
generating the aggregated data from the individual data in a case where the individual data is aggregated into the aggregated data; and
displaying the individual data in a case where the individual data is not aggregated into the aggregated data and displaying the aggregated data in a case where the individual data is aggregated into the aggregated data.

10. A computer program product comprising a non-transitory computer-readable medium including programmed instructions, the instructions causing a computer to function as:
a determining unit configured to determine whether to aggregate individual data into aggregated data using a narrowing condition for the individual data;
a generating unit configured to generate the aggregated data from the individual data in a case where the individual data is aggregated into the aggregated data; and
a display control unit configured to display the individual data in a case where the individual data is not aggregated into the aggregated data and displays the aggregated data in a case where the individual data is aggregated into the aggregated data.
